(19) United States
(12) Patent Application Publication
(10) Pub. No.: US 2004/0064388 A1
(43) Pub. Date: Apr. 1, 2004

(54) Electronic invoice processing system with a data module set for each customer system

(76) Inventor: Julie Violet Pierce, (US)

Correspondence Address: Grossman Tucker Perreault & Pfleger, PLLC, 55 South Commercial Street, Manchester, NH, 03101, US

(21) Appl. No.: 10/260,934

(22) Filed: Sep. 30, 2002

(51) Int. Cl. G06F 17/60

(52) U.S. Cl. 705/34

(57) ABSTRACT

A method of processing data in an invoice processing system having a plurality of customer systems includes the steps of: identifying each of the plurality of customer systems; and creating a data module set associated with each of the plurality of customer systems. An electronic billing system includes a plurality of customer systems and a data center configured to receive data from the plurality of customer systems, where the data center includes a data base. The data base further includes a data module set for each of the plurality of customer systems.

### FIELD OF THE INVENTION

The present invention relates generally to an internet-based electronic invoice processing system, and in particular to such a system having a single data module set for each customer system.

### BACKGROUND OF THE INVENTION

Various internet-based electronic invoice processing systems are known in the art whereby a vendor can electronically create and present a bill to a customer for review. Such systems may also incorporate electronic payment features. Such electronic systems have the advantage of displacing traditional paper-based billing and payment methods. As such, efficiencies can be realized for both a vendor and customer by avoiding associated manual work created by such traditional paper-based billing and processing methods.

Data relating to customers, vendors, invoices, rules, matters, etc. is typically organized in a relational database. The relational database contains a plurality of tables. For description purposes, one or more of such tables may be grouped together in a “data module.” For instance, there may be a matters data module, invoices data module, etc. An associated plurality of data modules is referred to herein as a “data module set.”

Known invoice processing systems typically utilize a variety of tables. However, as the number of vendors and customers using such a system increase, the processing speed of the system can be delayed if excessively large tables are created. In addition, if such excessively large tables include data from a plurality of customers, there is a chance data from one customer could be inadvertently commingled with data from another customer. Such results are unacceptable especially when such data is sensitive invoice data. In some instances, e.g., when the vendor is a law firm and the customer is a corporate client of the law firm, confidential information may even be part of data stored in such tables.

Accordingly, there is a need for an invoice processing system having a separate set of data modules for each customer system.

### BRIEF SUMMARY OF THE INVENTION

A method of processing data in an invoice processing system having a plurality of customer systems, wherein the method consistent with the invention includes the steps of: identifying each of the plurality of customer systems; and creating a data module set associated with each of the plurality of customer systems.

An electronic billing system consistent with the invention includes: a plurality of customer systems; and a data center configured to receive data from the plurality of customer systems, the data center including a data base, wherein the data base includes a data module set for each of the plurality of customer systems.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an electronic invoice processing system consistent with the invention;

FIG. 2 is a block diagram of the data base of FIG. 1 illustrating an exemplary data base containing a data module set for each customer; and

FIG. 3 is a flow chart illustrating how each vendor can provide data to each data module set from a common log on routine.

### DETAILED DESCRIPTION

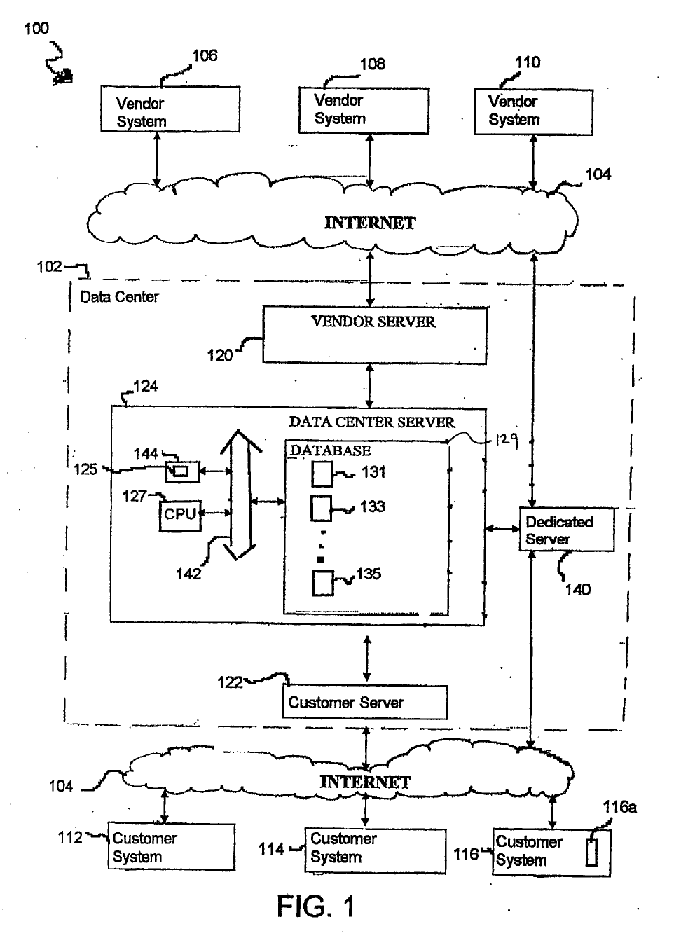

FIG. 1 illustrates a web-based electronic invoice processing system 100 consistent with the invention. In general, the system 100 includes a data center 102 coupled via the internet 104 to various vendor systems 106, 108, 110 and customer systems 112, 114, 116. The data center 102 serves as a centralized repository for storing, managing, and processing data related to invoice generation, analysis, and payment as further detailed herein. The data center 102 includes a vendor server 120, a customer server 122, a data center server 124, and a dedicated server 140. In one of many embodiments, the system 100 may be used as a legal e-billing system enabling a plurality of law firms (vendor systems) and their client corporations (customer systems) to engage in electronic invoice processing and payment.

In general, the system 100 permits vendor systems 106, 108, 110 to present invoices, in electronic form, to various customer systems 112, 114, 116, and allows customer systems 112, 114, 116 to automate a number of invoice review and processing operations as detailed further herein.

The vendor systems 106, 108, 110 and customer systems 112, 114, 116 represent parties that participate in the system 100. Each party may have one or more computer workstations having appropriate hardware and browser software, e.g., Netscape Navigator™ or Microsoft Internet Explorer™, and/or direct real-time Transmission Control Protocol/Internet Protocol (TCP/IP), for permitting human users to send to, and receive data from, the data center 102 and to control various operations of the data center 102 in real time and/or batch type transactions. To provide secure transmissions over the internet 104, the browser software should preferably have a minimum 128-bit encryption capability. As such, all files, e.g., invoice files, matter files, and timekeeper files, are encrypted when they are sent over the internet 104 to an associated server 120, 122.

Each vendor system 106, 108, 110 or customer system 112, 114, 116 may also have one or more associated servers, e.g., server 116a for customer system 116, that run associated applications. For instance, each vendor system 106, 108, 110 may have any one of a plurality of time and billing software systems, and each customer system 112, 114, 116 may have any one of a plurality of matter management systems or accounts payable systems.

In order to communicate and integrate with such outside systems of each vendor system and customer system, the system 100 may be further equipped with a dedicated server 140 that is configured to transfer and receive data to and from associated servers of vendors or customers using a predetermined communication protocol. For example, such a server 140 may be a File Transfer Protocol (FTP) server that can exchange files using FTP protocol to an associated server of any vendor systems 106, 108, 110 or customer systems 112, 114, 116.

For example, server 116a of customer system 116 may transfer matter management data from its matter management system to the server 140. The data center server 124 may then later accept such data for use in any of its processes. The data center server 124 may also transfer data, e.g., invoice data, to the server 140 so that the server 140 can later communicate such data to the accounts payable system of customer system 116 via server 116a. As such, the server 140 provides a way to integrate the data center 102 with disparate systems of any vendor or customer.

The vendor server 120 and customer server 122 are illustrated and described herein as separate server software applications operated on separate hardware systems for clarity of description. Those skilled in the art will recognize however, that such functionality for each could be combined on one server application or in multiple server applications operating on a single hardware system. Access to the servers 120, 122 by the vendor systems 106, 108, 110 and customer systems 112, 114, 116 may be through a variety of communication channels over the internet 104 such as point-to-point leased line/frame relay, public internet via an internet service provider, or a virtual private network (VPN) to name a few.

In addition, data transfers between vendor systems 106, 108, 110 and customer systems 112, 114, 116 to the data center server 124 may use a predetermined communication protocol as well so that the data content of the files is recognized by the data center server 124 and the “associated application” at the vendor systems 106, 108, 110 or customer systems 112, 114, 116. For instance, in transferring invoice data from a vendor system 106, 108, 110 to the data center 102 a standard format such as the LEDES™ electronic invoice standard coordinated by PriceWaterhouseCoopers may be utilized.

The vendor server 120 is a software application that provides services to other client software applications in a client/server relationship. In one instance, the vendor server 120 provides services to the vendor systems 106, 108, 110. In another instance, the vendor server 120 acts as a client in making requests to the data center server 124 which fulfills such requests. For instance, the data center server 124 may provide view matter, review invoices, and submit invoice transactions to the vendor server 120. The vendor server 120 builds a Hypertext Markup Language (HTML) or other graphical user interface (GUI) document in accordance therewith. A GUI document is then provided to the vendor system 106, 108, 110 which displays various GUI documents. Such GUI documents enable the user to perform a variety of functions such as viewing matters assigned to them, reviewing invoices, and submitting invoices and timekeepers.

Similar to the vendor server 120, the customer server 122 is a software application that provides services to other client software applications in a client/server relationship. In one instance, the customer server 122 provides services to the customer systems 112, 114, 116. In another instance, the customer server 122 acts as a client in making requests to the data center server 124 which fulfills such requests. The customer server 122 builds an HTML or other GUI document in accordance with such request. A GUI document is then provided to the customer system 112, 114, 116 which displays such documents. Such GUI documents enable a customer user to perform a variety of functions such as reviewing invoices, and creating billing rules for such invoices.

The data center server 124 of the data center 102 includes a processor 127 which operates data center server applications 125 that perform the main processing operations for the system 100. The data center server applications 125 may include a variety of software routines that may be stored on any variety of machine readable media 144 for execution by the CPU 127. The processor 127 of the data center server 124 can be any type of processor capable of providing the speed and functionality required by embodiments of the invention. For example, the processor could be a processor from the Pentium® family of processors made by Intel Corporation.

The machine-readable media 144 can be any type of media capable of storing instructions adapted to be executed by the processor 127. Some examples of such media include, but are not limited to, system RAM, read only memory (ROM), programmable ROM, magnetic disk (e.g., floppy disk and hard disk drive), optical disk (e.g., CD/DVD ROM), and any other device that can store digital information. As used herein, the phrase “adapted to be executed by a processor” is meant to encompass instructions stored in compressed and/or encrypted format, as well as instructions that have to be compiled or installed by an installer before being executed by the processor. The processor 127 and machine-readable media 144 may be part of various components of the data center 102 and data center server 124 where various combinations of machine-readable media may store combinations of the rules engine software which are accessible by the processor through various controllers.

The data center server 124 also includes an extensive database 129 that contains aggregations of data records. Such data records relate to vendor systems 106, 108, 110, customer systems 112, 114, 116, and associated information. The database 129 is a relational database such as a DB2 database from IBM Corporation that can manage the large volumes of data to be stored and processed by the data center server 124. A standard user and application program interface to such a relational database is structured query language (SQL).

Advantageously, the database 129 includes a plurality of data module sets 131, 133, 135, associated with each respective customer 112, 114, 116. In other words, data module set 131 references relevant data for customer system 112, data module set 133 references relevant data for customer system 114, and data module set 135 references relevant data for customer system 116. Any number of customers and data module sets may be utilized in a system consistent with the invention. As such, each customer's data is organized in segregated tables enhancing the security of such data and improving processing speed by avoiding excessively large tables.

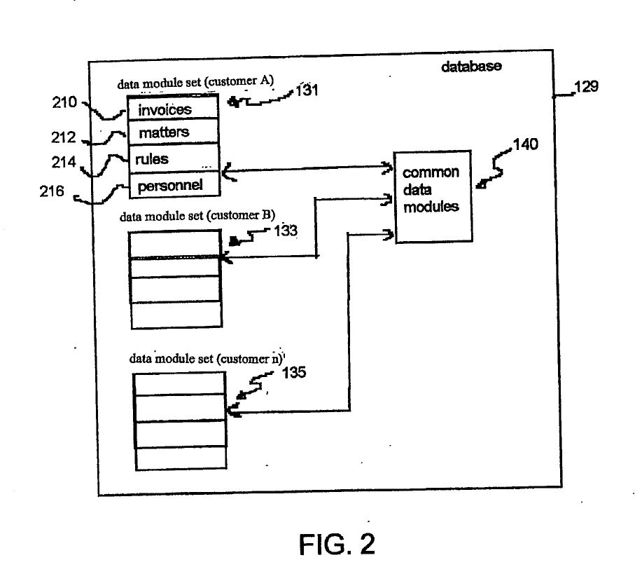

Turning to FIG. 2, more details of the database 129 of FIG. 1 are illustrated. Each data module set 131, 133, 135 may contain a variety of different data modules. For example, data module set 131 associated with customer system 112 or customer system A, may include an invoices data module 210, a matters data module 212, a rules data module 214, and a personnel data module 216 to name several. Other data modules or different data modules may be included in each data module set.

In general, the invoices data module 210 contains references to invoice related data submitted by the various vendors 106, 108, 110 to customer 112. The matters data module 212 contains references to basic information to identify and describe various matters for customer 112. The rules data module 214 contains references to rule data defined by the customer 112. Finally, the personnel data module 216 contains references to various personnel of the customer 112, e.g., personnel for reviewing and approving invoices. Similarly, other data module sets 133, 135 may contain similar data for their associated customer.

In addition to the data module sets 131, 133, 135 associated with each customer, there may also be other data modules 140 that are common to the system which are not duplicated for each customer. Such common data modules 140 may include any data, e.g., a lookup table, which is not dependent on, or specific to, a particular customer. Such a common data module 140 may be linked to each specific data module set 131, 133, 135, but advantageously each customer specific data module set 131, 133, 135 is not linked to each other in any fashion.

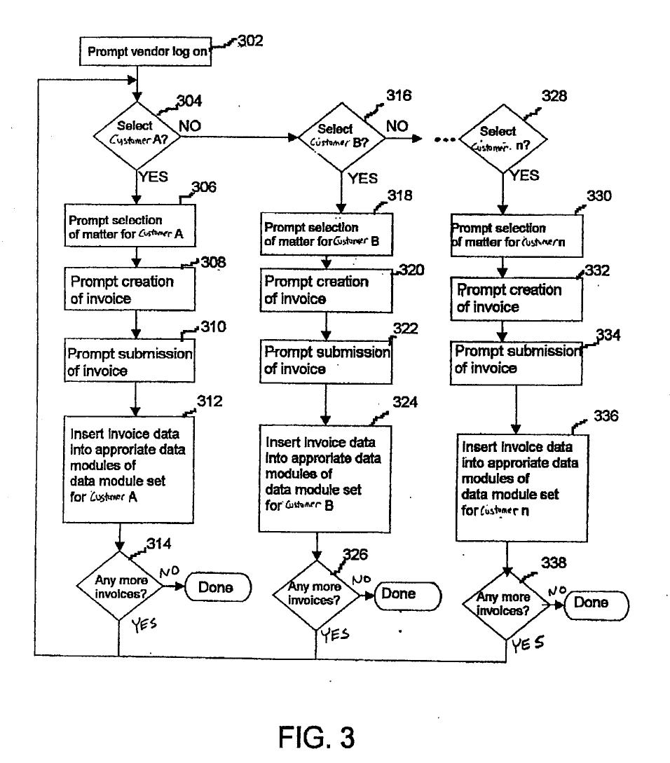

Turning to FIG. 3, a flow chart 300 demonstrating a process where each vendor 106, 108, 110 can provide data for use in each data module set from a common log on routine is illustrated. Such a process may be facilitated by a variety of application software 125 stored on the machine-readable medium 144. For simplicity, the process 300 is described with reference to invoice creation and submission although other applications are contemplated herein. In step 302, the application 125 prompts a vendor to log onto the system 100. This log on routine is commonly accessible to each vendor.

The application then prompts the vendor to select a particular customer in steps 304, 316, 328. If the vendor selected customer A in step 304, the application would prompt selection of a particular matter for customer A 306. The vendor would also be prompted to create an invoice 308 and submit the invoice 310. The application would then insert references to the submitted invoice data into appropriate tables of an appropriate data module of the data module set for customer A. For example, invoice related data may be inserted into an invoices table of the invoices data module 210 of the data module set 131 for customer A. The vendor could then be queried to create another invoice in step 314. If the vendor chose to submit another invoice, the process would loop back to selection of the same or separate customer and continue again until the vendor had submitted all applicable invoices.

Similarly, the application enables the vendor to select customer B 316 or any other customer up to customer n 328 and create data, e.g., invoice data, for insertion into a proper data module set for each particular customer. As such, sensitive data for each particular customer is segregated from another.

When a new customer is added to the system 100, particular details from the customer are ascertained in order to allocate resources and properly create a new data module set for that particular customer. In creating tables for each customer, a programmer must perform a number of tasks including, but not limited to, defining field names, defining the type (e.g., numeric or alphanumeric) of data to be entered into each field, defining the maximum character length for each field, defining the key fields for each table that uniquely identifies a row of that table, defining an index field, and defining the number of rows.

Although there should be consistencies among the data module sets, some tables within each set may be different depending on the unique characteristics or requirements of each customer. For example, one customer may have a large amount of matters compared to another. As such, the matters table of such a customer should have more rows than a matters table for the customer with fewer matters.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A method of processing data in an invoice processing system comprising a plurality of customer systems, said method comprising the steps of:
identifying each of said plurality of customer systems; and
creating a data module set associated with each said plurality of customer systems.

2. The method of claim 1, wherein each said data module set comprises a plurality of data modules, wherein said plurality of data modules are selected from the group consisting of an invoices data module, a matters data module, a rules data module, and a personnel data module.

3. The method of claim 2, wherein each said plurality of data modules comprises at least one table.

4. The method of claim 1, wherein said invoice processing system further comprises a plurality of vendor systems, and said method further comprises the step of:
enabling each of said plurality of vendor systems to provide data to each said data module set from a common log on routine.

5. The method of claim 1, wherein each said data module set comprises a plurality of data modules, and each of said data modules comprises at least one associated table, and for each said table said creating step comprises:
defining a plurality of fields; and
defining at least one of said plurality of fields as a key field.

6. An electronic billing system comprising:
a plurality of customer systems; and
a data center configured to receive data from said plurality of customer systems, said data center comprising a data base, wherein said data base comprises a data module set for each of said plurality of customer systems.

7. The system of claim 6, wherein said data module set comprises a plurality of data modules, wherein said plurality of data modules are selected from the group consisting of an invoices data module, a matters data module, a rules data module, and a personnel data module.

8. The system of claim 7, wherein each said plurality of data modules comprises at least one table.

9. The system of claim 7, further comprising a plurality of vendor systems, wherein each said plurality of data modules may accept data input by one of said plurality of vendor systems.
